(19) United States
(12) Patent Application Publication
(10) Pub. No.: US 2013/0188335 A1
(43) Pub. Date: Jul. 25, 2013

(54) ARM WEARABLE ILLUMINATING DEVICE

(71) Applicants: Yves Frederic Emile MARCHE, Cabourg (FR); Annie Adrienne Pigneux-Marche, Cabourg (FR)

(72) Inventors: Yves Frederic Emile MARCHE, Cabourg (FR); Annie Adrienne Pigneux-Marche, Cabourg (FR)

(21) Appl. No.: 13/439,548

(22) Filed: Apr. 4, 2012

(30) Foreign Application Priority Data
Jan. 19, 2012 (TW) 101201402

(51) Int. Cl. F21V 21/108

(52) U.S. Cl. 362/103

(57) ABSTRACT

A arm wearable illuminating device comprises a bendable carrier, which is a bendable long-sheet-shape body; a plurality of illuminating element, which are evenly installed along long-axis direction of one side of the bendable carrier, and illuminate outwardly from the mounted surface; a transparent protective unit, which wraps the said bendable carrier and the said illuminating elements, and allows the emitting light from the illuminating elements transmitting through the transparent protective unit and displaying luminance; and a power supply device, which provides the electric power to the illuminating element for emitting light and controls the on-off status; thereby, the invention of the arm wearable illuminating device is operatively bendable for mounting on the arm, and is operatively stretchable for dismounting off the arm.

### BACKGROUND OF THE INVENTION

This present invention relates to optical components, electronic components, textile materials and plastic materials for constructing an illuminating device, particularly for an arm wearable illuminating device, which provides controllable illumination.

The invention presents an arm wearable illuminating device, which is operatively bendable for mounting on the arm, and is operatively stretchable for dismounting off the arm, moreover provides alarming illumination.

According to the prior arts, the light-reflective belts are widely adopted in the daily life for reflecting the incident light and raise the visual attention, and subsequently warn others to the appearance of the persons who wearing the light-reflective belts. However, the light-reflective belts may not produce the expected effects in the absence of the illumination, therefore are considered as passive alarming devices. Another scenario is that if the incident illumination is dim, the corresponding reflective light is relatively faint, and therefore the warning efficiency is rather low, namely, the light-reflective belts of the prior arts are lacking of self-illuminating function, which limit the capability of providing safety for those wearing the said belts in the dark locations.

Moreover, some recent arts demonstrate active light-reflective devices, which use light emitting diode (LED) installed on the products with alerting functions for use in the dark environment, and provide the safety of the user carrying them. The aforementioned products with alerting functions normally embed the LED's in a fixed structure, therefore are neither ready for hand-free carrying and nor for wearable on the arms, thereby limit the flexibility of usage and do not meet the user's requirement.

In order to solve the limitations of the prior arts, the objective of the invention is to provide a structural improvement in form of arm-wearable light-emitting device for overcoming the limitations.

### SUMMARY OF THE INVENTION

The prime objective of this invention is to provide an arm-wearable light-emitting device for improving the limitations of the prior arts, and to provide the users an alternative solution for product selection and replacement; more precisely, this invention hereby provides an arm-wearable illuminating device, which is furnished with specific structure thus enables the whole assembly more simple and convenient to use.

In order to attend the above objective, the invention provides an arm wearable illuminating device, which comprises a bendable carrier, a plurality of illuminating element, a transparent protective unit, and a power supply device; thereby the said bendable carrier is a bendable long-sheet-shape body; the said illuminating elements are installed along long-axis direction of one side of the said bendable carrier, and illuminate outwardly from the mounted surface; the said transparent protective unit thereby at least wraps the said bendable carrier and the said illuminating elements, and allows the emitting light from the said illuminating elements transmitting through the transparent protective unit and displaying luminance; the said power supply device provides the electric power to the illuminating element for light emission and controls the on-off status of the said illuminating elements; thereby, the arm wearable illuminating device is operatively bendable for wrapping around the arm, and is operatively stretchable for removing off the arm. The aforementioned structure provides the bendable feature of the bendable carrier and allows the arm wearable illuminating device being conveniently mounted on the arm of the user, and further provides the protecting effect for the user via safety-alerting illumination.

### BRIEF DESCRIPTION OF THE DRAWINGS

FIG. 1 is a perspective view of the invented arm wearable illuminating device.

FIG. 2 is a separating view of the invented arm wearable illuminating device in conjunction with a pocket carrier.

FIG. 3 is an assembly view of the invented arm wearable illuminating device in a pocket carrier.

FIGS. 4A, 4B, and 4C show the operative sequence of mounting the arm wearable illuminating device on a user's arm.

FIG. 5 shows a bicycle rider wears a arm wearable illuminating device.

FIG. 6 shows the invented arm illuminating device in a pocket carrier further tied up with a displaying plate.

FIG. 7 shows a perspective view of the invented arm wearable illuminating device in another preferred embodiment.

### DETAILED DESCRIPTION OF THE PREFERRED EMBODIMENT

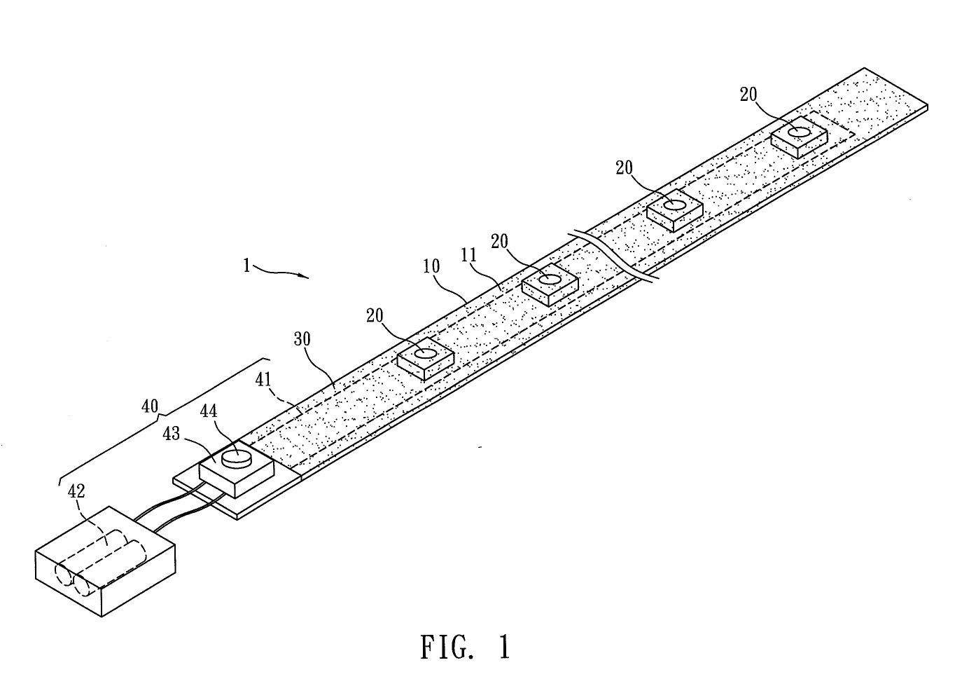

FIG. 1 shows the perspective view of the invented arm wearable illuminating device. The invented arm wearable illuminating device 1 is used for mounting on the user's arm and provides the protecting effect for the user via the safety-alerting illumination, thereby the said arm wearable illuminating device 1 comprises a bendable carrier 10, a plurality of illuminating element 20, a transparent protective unit 30, and a power supply device 40.

The bendable carrier 10 is a bendable long-sheet-shape body, thereby the bendable carrier 10 can be made of bendable plastic plate or bendable metallic plate, which is operatively bendable and stretchable.

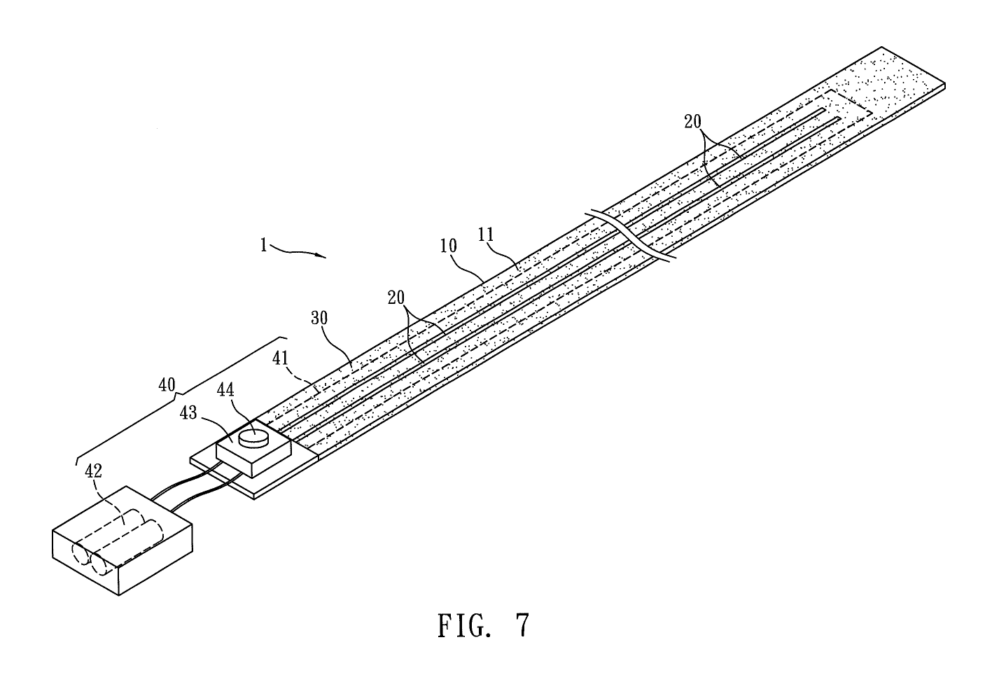

The said plurality of illuminating element 20 are installed along long-axis direction of one side of the said bendable carrier 10, and illuminate outwardly from the mounted surface, thereby the plurality of illuminating element 20 can be light emitting diodes (LED's), such as SMD 3528 LED's, which can be evenly attached in line along long-axis direction of the said bendable carrier 10 (as shown in FIG. 1); the said plurality of illuminating element 20 can also be constructed by a plurality of optical fiber, which are evenly attached along short-axis direction of the said bendable carrier 10 (as shown in FIG. 7).

The said transparent protective unit 30 at least wraps the said bendable carrier 10 and the said plurality of illuminating element 20, and allows the emitting light from the transmitting through the transparent protective unit 30, which can further wrap around the partial components of the said power supply device 40 for providing protective function; thereby the said transparent protective unit 30 can be made of materials with transparency, such as silicone.

The said power supply unit 40 provides the electric power to the said plurality of the illuminating element 20 for light emission and controls the on-off and twinkling status of the said plurality of illuminating elements 20; thereby, the said power supply unit 40 comprises an electronic circuit 41 for connecting electrically with the said plurality of illuminating element 20, and at least a piece of battery 42, which provides the electric power to the said plurality of illuminating element 20; thereby the said power supply unit 40 further comprises a controller 43, and utilizes the switch 44 for selecting the operation modes of the controller, such as “on”, “off”, and “twinkling”.

The said bendable carrier 10 in this invention presents good flexibly bendable characteristics, thereby enables the said arm wearable illuminating device 1 easily and conveniently mounted on user's arm, and thereafter protects safety of the user via alerting illumination. Further on the operations of mounting and dismounting the said bendable carrier 10, the user can swing the said bendable carrier 10 toward the arm when mounting the said bendable carrier 10, which will be wrapping around the arm via mechanic motion, and the user can stretch and pull the said bendable carrier 10 for easy dismounting; moreover, the good flexibly bendable characteristics makes the wearing tight without uncomfortable feeling.

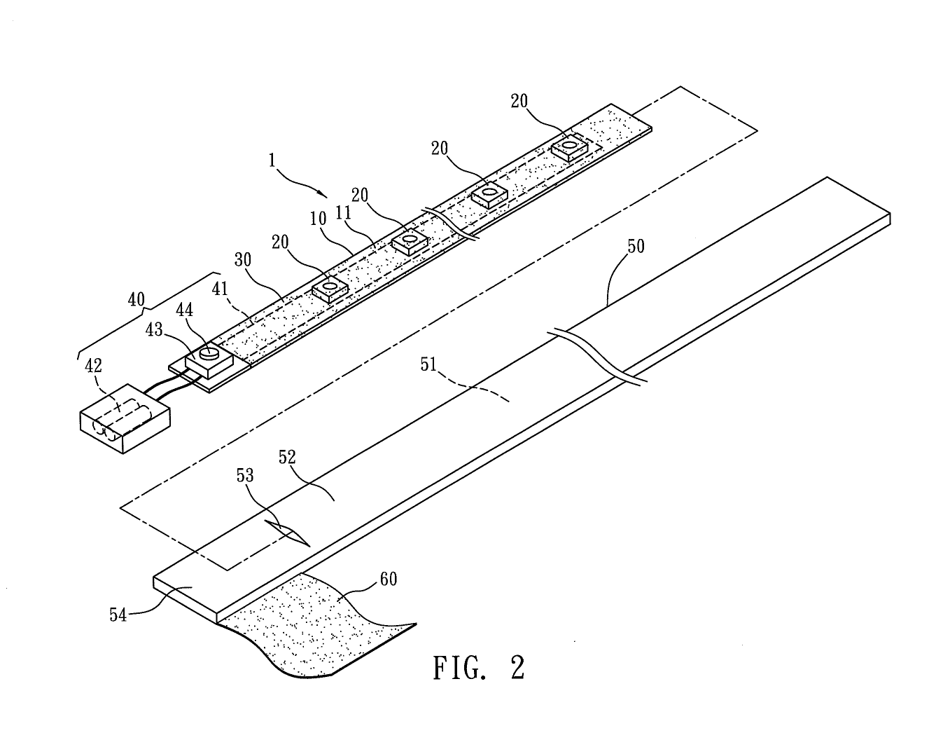

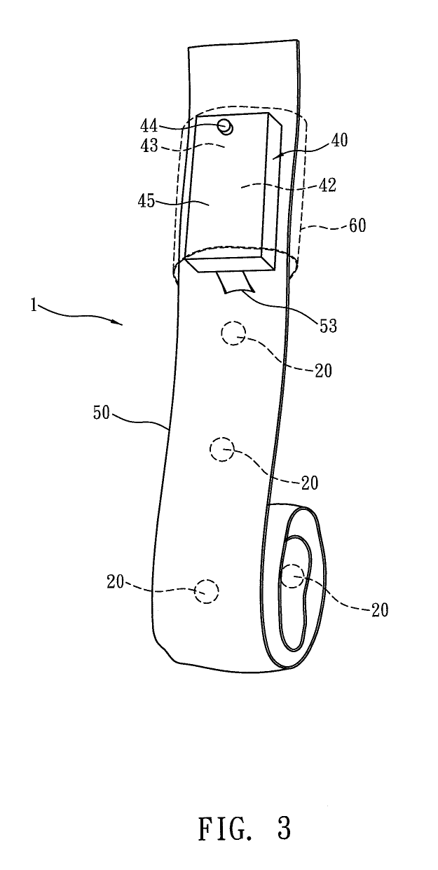

As shown in FIG. 2 and FIG. 3, the transparent protective unit 30 of the arm wearable illuminating device can be also in form of transparent long-shaped pocket carrier 50, which is a soft textile structure, but not limited to the materials of yellowish light-reflective soft textile, thereby the pocket carrier 50 comprises a containing area 51 for the said bendable carrier 10 and the said plurality of illuminating element 20, thereby the pocket carrier 50 further comprises a pocket wall 52, which defines the containing area 51, thereby the said pocket wall 52 comprises further an pocket opening 53, which allowing the said bendable carrier 10 and the said plurality of illuminating element 20 being inserted into the containing area 51, in the meantime, the power supply unit 40 being secured on the outer surface of the pocket carrier 50. When the said plurality of illuminating element 20 on the bendable carrier 10 illuminating, the emitting light can transmit through the pocket carrier 50 and displaying luminance, and providing the objective of light alerting; additionally, the partial components of the power supply unit 40 can be deposited into the containing area 51 of the pocket carrier 50.

Moreover, one terminal 54 of the said pocket carrier 50 further connects to a sheet body 60, thereby the sheet body 60 can wrap over the power supply unit 40 or partial components of the power supply body 40, and provides protective function, and improves the decorative effect, thereby the sheet body 60 can be formed partly but not limited to using Velcro, which providing convenient use, for example, allowing sheet body 60 being able to be conveniently wrapped and disjointed.

As shown in FIG. 3, the battery 42, controller 43, and switch 44 of the said power supply unit 40 can be further assembled and packed in a box body 45, as shown in the figure, the battery 42 and controller 43 are contained in the box body 45, while the switch 44 secured on the surface of the box body 45, thereafter saving the assembly time in the production line for this invention. Moreover, the good flexibly bendable characteristics of the bendable carrier 10, which matches the soft textile of the pocket carrier 50, therefore, the user can freely fold the arm wearable illuminating device into a small package, and further improving the portability and storage for the user.

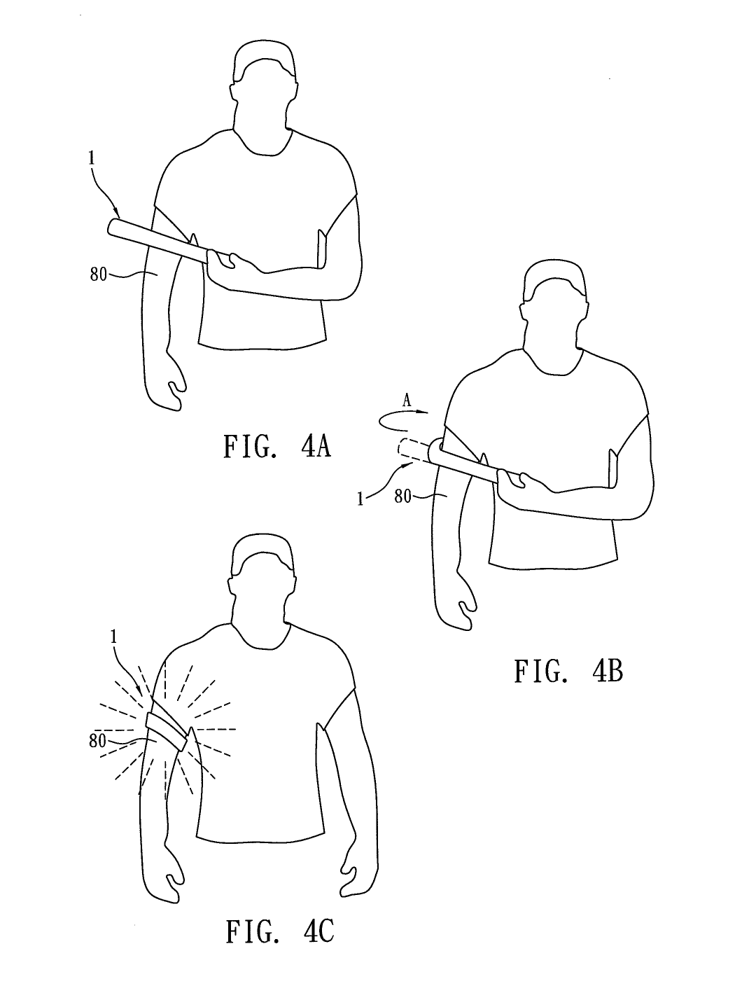

FIG. 4A through 4C show the operation procedure of the arm wearable illuminating device 1, as in this embodiment, the user mounts the arm wearable illuminating device 1 onto user's right arm; FIGS. 4A and 4B show the user holds the arm wearable illuminating device 10 on the left and swings it toward the right arm 80 (as in arrow “A” in FIG. 4B), thereby the flexibly bendable characteristics of the bendable carrier 10 makes itself bending and wrapping around the arm 80 and mounted (as shown in FIG. 4C).

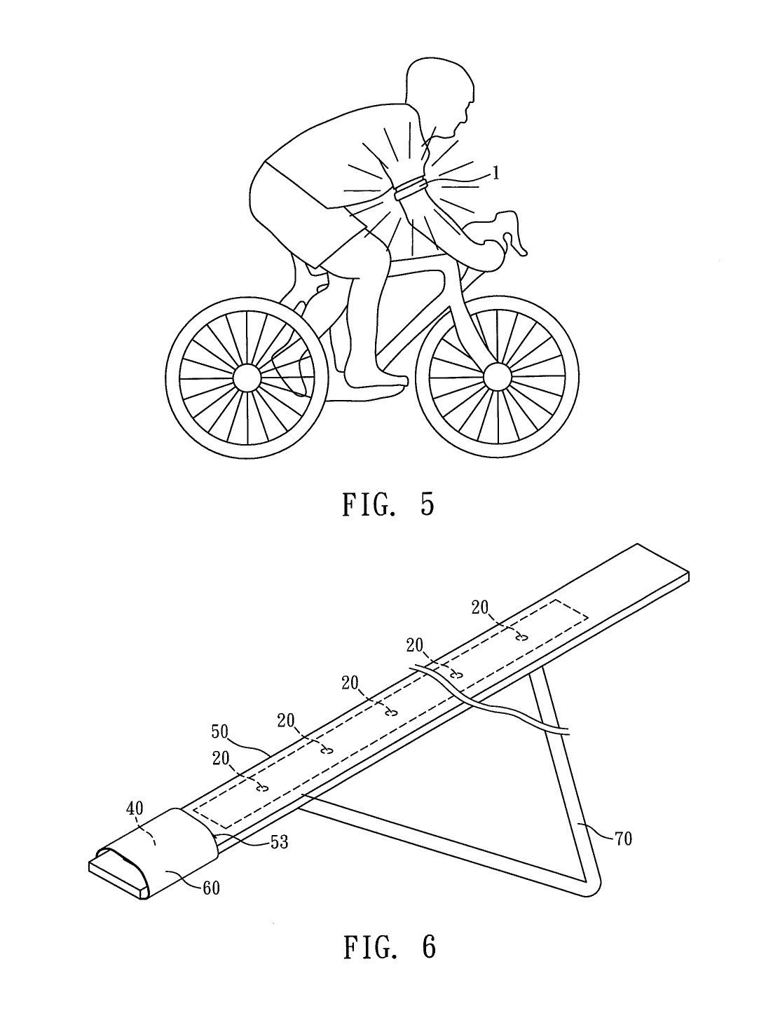

As shown in FIG. 4C, the arm wearable illuminating device 1 mounted on the arm 80 of the user can provide the user an alerting signal to the others when the user is in the darkness or low-visibility environments for the safety purpose. The old people, women, and children are also among the users of this arm wearable illuminating device 1 for self protection in the darkness or low-visibility environments. As shown in FIG. 5, the bicycle rider with the arm wearable illuminating device 1 mounted on the arm provides the rider showing alerting to a wider adjacent areas. When the user intends to alert by using the arm wearable illuminating device 1, he can press switch 44 for making the plurality of illuminating element 20 turned on, or twinkling, thereby the emitting light from the plurality of illuminating element 20 transmitting through the pocket carrier 50 and displaying to the external environment, and achieves the active light-emitting aim, therefore the design of the arm wearable illuminating device 1 of this invention not only demonstrates innovative structure, but also promotes the safety when using in the dark environments.

FIG. 6 shows that the pocket carrier 50 of the arm wearable illuminating device 1 tied up with a displaying plate 70, thereby the displaying plate 70 can show various patterns based on the user's demands, such as visual recognition, decoration, or advisement, and further can expand the applications of this invention.

Comparing with the prior arts, the invention provides the arm wearable illuminating device 1 comprising active light sources for improving the altering effect for user safety; in addition, the flexibly bendable characteristics of this device makes the mounting and dismounting rather easy and convenient. From the production perspective, this invention can divide different production lines for the pocket carrier 50, the bendable carrier 10, and the plurality of illuminating elements connecting to the power supply unit 40, and therefore increase the flexibility of production, and simplify the overall production.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An arm wearable illuminating device for mounting on the user's arm for safety alerting, which comprising:
a bendable carrier, which being a bendable long-sheet-shape body made of either bendable plastic plate or bendable metallic plate;
a plurality of illuminating element, which being installed along long-axis direction of one side of the said bendable carrier, and illuminating outwardly of the mounted surface;
a transparent protective unit, which wrapping over the said bendable carrier and said plurality of illuminating element, and allowing the emitting light from the said plurality of illuminating element transmitting through for displaying luminance; and
a power supply unit, which comprising
an electronic circuit for connecting the said plurality of illuminating element; and at least a battery for providing electric power to the said plurality of illuminating element;
wherein, the said arm wearable illuminating device being operatively bendable for wrapping around the arm, and being operatively stretchable for removing off the arm

2. An arm wearable illuminating device as claimed in claim 1, wherein the said transparent protective unit further wraps around the partial components of the said power supply unit.

3. An arm wearable illuminating device as claimed in claim 1, wherein the said plurality of illuminating unit is constructed by a plurality of light emitting diode (LED), which being attached in line along long-axis direction of the said bendable carrier.

4. An arm wearable illuminating device as claimed in claim 1, wherein the said plurality of illuminating unit is constructed by a plurality of optical fiber.

5. An arm wearable illuminating device as claimed in claim 1, wherein the transparent protective unit is made of transparent silicone.

6. An arm wearable illuminating device as claimed in claim 1, wherein the said transparent protective unit is in form of a transparent long-shaped pocket carrier, which comprises a containing area for the said bendable carrier, the said plurality of illuminating element, and the partial components of the said power supply unit.

7. An arm wearable illuminating device as claimed in claim 6, wherein the said pocket carrier is made of soft textile.

8. An arm wearable illuminating device as claimed in claim 6, wherein one terminal of the said pocket carrier further connecting to a sheet body, which can wrap over the power supply unit or partial components of the power supply body.

9. An arm wearable illuminating device as claimed in claim 8, wherein the said sheet body is made of Velcro.

10. An arm wearable illuminating device as claimed in claim 6, wherein the said pocket carrier further comprises a displaying plate on one of the side surfaces.

11. An arm wearable illuminating device as claimed in claim 1, wherein the said power supply further comprises a controller and a switch, thereby the switch is used for selecting one the operation modes of the controller, “on”, “off”, and “twinkling”.
